(19) United States
(12) Patent Application Publication
(10) Pub. No.: US 2008/0143512 A1
(43) Pub. Date: Jun. 19, 2008

(54) Wireless communication system and wireless terminal apparatus for sensor network

(76) Inventors: Yoshihiro WAKISAKA, Kokubunji (JP); Norio OHKUBO, Tokyo (JP); Norihiko MORIWAKI, Hachioji (JP); Miki HAYAKAWA, Cambridge, MA (US)

Correspondence Address: REED SMITH LLP, Suite 1400, 3110 Fairview Park Drive, Falls Church, VA, 22042, US

(21) Appl. No.: 12/000,136

(22) Filed: Dec. 10, 2007

(30) Foreign Application Priority Data
Dec. 14, 2006 (JP) 2006-337461

(51) Int. Cl. G08B 23/00

(52) U.S. Cl. 340/504; 340/10.2; 340/286.01

(57) ABSTRACT

A wireless terminal comprising a radio transceiver for communicating with a base station, an infrared transceiver for communicating with another wireless terminal, a congestion control unit for detecting whether radio communication with the base station is in a collision-free state, and a communication control unit for performing radio communication with the base station by the radio transceiver after detecting unoccupied state in the radio channel by the congestion control unit and transmitting identification information to another wireless terminal by the infrared transceiver when the radio communication with the base station is completed.

### CLAIM OF PRIORITY

The present application claims priority from Japanese application serial No. 2006-337461, filed on Dec. 14, 2006, the content of which is hereby incorporated by reference into this application.

### BACKGROUND OF THE INVENTION

(1) Field of the Invention

The present invention relates to a wireless communication system, more specifically to a wireless communication system and a wireless terminal apparatus suitable for a sensor network which collects information from a plurality of wireless terminals each provided with a sensor.

(2) Description of Related Art

Research and development of a network system which collects information in real time from a small wireless terminal apparatus carrying a sensor are progressing these days. Hereinafter, such a network system is called a sensor network and the small wireless terminal apparatus carrying a sensor is called a sensor node. The sensor network is a network system in which the status of a person, an object, and environment is sensed by a plurality of sensor nodes, and the information of the sensed status is transmitted to a management apparatus (monitoring center) in real time via a wireless network. By equipping each sensor node with a power source (battery) and a wireless communication function, the sensor network does not require wired connection between each sensor node and a relay network. Therefore, situation surveillance which has been impossible until now becomes possible, by arbitrarily arranging the sensor node at a necessary place in an area where communication with a wireless base station is available.

The sensor network comprises a plurality of base stations connected to a relay network (intranet/Internet), a plurality of sensor nodes located around each base station, and a management apparatus connected to the relay network. An ordinary computer or a server is applied as the management apparatus. Each sensor node carries out sensing of the state of a person, an object, or environment appropriately, and transmits to the base station a data packet including the sensing data and the sensor node ID by wireless in a predetermined communication frame format.

The base station adds control information such as a time stamp and a base station ID to the data packet received from the sensor node, and transmits the data packet to the management apparatus via a relay network (intranet/Internet). The management apparatus (monitoring center), for example, a server, stores information including sensing data, a sensor node ID, a time stamp, a base station ID, etc. received from each base station, and conducts the data management and data analysis depending on the purpose of the system.

The sensor node is expected to be small-sized, light-weighted, and able to operate free of maintenance for a long time, for example, in order to be installed with easy operation in a supervisory area, or to be worn by a person without limiting his or her free motion. In order to operate long-duration with a small-sized battery, each sensor node is needed to reduce its power consumption as much as possible.

As an example of reduction measure of the power consumption of a sensor node, a method is known to reduce the consumed electric currents significantly wherein the state of the sensor node is made switchable between an active mode in which the sensor node performs sensing and wireless communications and a standby mode in which the sensor node is in a dormant state of operation. The sensor node is intermittently switched to the active mode, otherwise stays in the standby mode. During the period of the standby mode, electronic circuitries (including a processor) except a timer are turned into a power OFF state, thereby reducing the consumed electric currents.

The information gathering in the sensor network mentioned above is not restricted to a simple sensing by the sensor. For example, it becomes possible to supervise the state of interaction among sensor nodes by mounting an infrared transceiver in each sensor node in addition to a radio transceiver, and making each sensor node periodically transmit its node identifier by the infrared transceiver and report the receiving state of node identifiers from other sensor nodes to the management apparatus. In this case, it becomes possible to detect the spatial relationship and the change of interaction between the sensor nodes, by transmitting an infrared ray with the directivity of a certain degree from each sensor node, so that the node identifier may be communicated normally only between the sensor nodes whose infrared transceivers are positioned in a face-to-face spatial relationship.

As a system detectable the object in a facing state by transmitting and receiving identifier (ID) information by an infrared ray, there is, for example, an infrared location system EIRIS (ELPAS Infra-Red Identification and Search system) of ELPAS (Electro-Optical Systems) in Israel. In this system, a transmitter called a badge transmits a signal including a source badge ID every 4 seconds using the diffusion infrared system, the receiver called a reader receives the signal. By analyzing the received signal with a control PC, the position of a person who puts on the badge is monitored.

In the system using such a wearable sensor node, when a plurality of nodes transmit infrared signals at the same timing, discrimination of each signal on the receiving side becomes difficult due to collision or overlapping of the transmission signals. For that reason, in IrDA which is a standard of the infrared communication, the failure due to the collision and conflict of the infrared signals is recovered, by making a premise that each node (terminal) having received an infrared signal normally should transmit an acknowledgement (ACK) signal to a transmitting side and making the transmitting side retransmit the same signal if the transmitting side can not receive the ACK signal within a predetermined time after transmitting the infrared signal.

As a method of avoiding conflict of wireless signals, for example, Japanese patent application laid-open No. 2005-45330 (Document 1) proposes a wireless access point with a wireless LAN module and a Bluetooth module which differ mutually in the communication mode, wherein a control unit of the wireless access point generates a communication timing control signal based on the communicating state in each communication mode and operates the two modules in a mutually different time period based on the communication timing control signal. More specifically, a first period is assigned to the wireless LAN communication in the polling system, allowing the wireless access point to communicate with a plurality of personal computers each equipped with a wireless LAN interface, and a second period is assigned to the Bluetooth communication in the non-polling system, allowing the wireless access point to communicate with a plurality of personal computers each equipped with a Bluetooth interface.

WO 2002/091683 (Document 2) proposes a communication collision prevention method applicable to a system that unifies a first communication system and a second communication system. In the first communication system, each wireless terminal communicates with other wireless terminals via a control station which functions as an access point. In the second communication system, each wireless terminal communicates with other wireless terminals without passing through the control station, like an adhoc network. According to Document 2, each terminal is provided with a transceiver for the first communication system, and a transceiver for the second wireless system. A wireless terminal which wants to use the second communication system requests, based on the network information reported from the control station of the first communication system, the control station to assign a channel for the second communication system. The wireless terminal transmits information to other wireless terminals based on channel assignment information received from the control station.

### SUMMARY OF THE INVENTION

In a sensor network, it is necessary not only to avoid the communication collision between a base station and sensor nodes, but also to avoid the congestion in communication between sensor nodes. Especially, for a small-sized sensor node like a badge-type sensor node in which wearability is emphasized, a simple configuration to avoid such congestion is desired. However, in either of Document 1 and Document 2, the control station to be an access point controls the transmission time period of two communication systems having different information transmission formats from each other. Therefore, a special function is required for the control station.

An object of the present invention is to provide a wireless communication system and a wireless terminal apparatus which can avoid easily the congestion of communication not only between a base station and sensor nodes but also among sensor nodes.

Another object of the present invention is to provide a wireless terminal apparatus for sensor networks which is effectively operable with reduced power consumption.

In order to attain the above-mentioned objects, a wireless terminal apparatus according to one embodiment of the present invention comprises: a first wireless transceiver for communicating with a base station; a second wireless transceiver for communicating with the other wireless terminals; a congestion control unit for detecting whether the base station is in the state of wireless communication with one of the other wireless terminals; and a communication control unit for performing wireless communication with the base station by the first wireless transceiver after confirming by the congestion control unit that the wireless communication is in a collision-free state, and for transmitting information to at least one of the other wireless terminals by the second wireless transceiver when the wireless communication with the base station was completed.

Here, the congestion control unit judges, for example, by carrier sensing, whether the wireless communication with the base station is in a state where no collision occurs. The second wireless transceiver is an infrared transceiver, for example, and transmits the identification information of the wireless terminal to other wireless terminals.

According to the wireless terminal apparatus of the present invention, since the wireless communication with the base station by the first wireless transceiver is performed after the congestion control unit detects that wireless communication is in a state where no collision occurs, there are very few possibilities that a plurality of transmission frames conflict in the base station. Further, the information transmission to other wireless terminals by the second wireless transceiver starts when the wireless communication with the base station was completed. At this time, each of the other wireless terminals is either in a waiting state, in a state of detecting the unoccupied state of a wireless channel, or immediately after the start of wireless communication with the base station, and no communication with the other terminals is started. Accordingly, as long as the information transmission by the second wireless transceiver, for example, the infrared transceiver, is completed in a time shorter than a time required for performing communication with the base station, a possibility of conflicting with the information transmission from the other wireless terminals is also very small.

In more detail, the wireless terminal apparatus according to one embodiment of the present invention further includes a memory for storing the information received from other wireless terminals by the second wireless transceiver, and the communication control unit transmits to the base station a communication frame including the information received from the other wireless terminals and stored in the memory. In addition to the information, the communication frame may include sensing data detected by a sensor which is provided in the wireless terminal apparatus.

In the wireless terminal apparatus according to one embodiment of the present invention, the communication control unit enters an active mode in a predetermined cycle and performs detection of the wireless communication state by the congestion control unit and wireless communications by the first wireless transceiver and the second wireless transceiver, and transits to a standby mode after completing information transmission to one of the other wireless terminals.

A wireless communication system according to the present invention comprises a plurality of wireless terminals, and a plurality of base stations connected to a management apparatus via a network,

wherein each of the wireless terminals includes: a first wireless transceiver for communicating with one of the base stations; a second wireless transceiver for communicating with the other wireless terminals; a congestion control unit for detecting whether wireless communication with the wireless base station is in a collision-free state; and a communication control unit for performing wireless communication with the base station by the first wireless transceiver after confirming by the congestion control unit that the wireless communication is in a collision-free state, and transmitting information to at least one of the other wireless terminals by the second wireless transceiver when the wireless communication with the base station by the first wireless transceiver was completed, and

wherein each of the base stations forwards content of a communication frame received from each of the wireless terminals to the management apparatus.

According to the present invention, since the conflict and congestion in communication not only between the wireless terminal apparatus and the base station but between wireless terminal apparatuses are effectively avoidable, the wireless terminal apparatus and a wireless communication system with few retransmitting operations of the same frame can be provided.

### BRIEF DESCRIPTION OF DRAWINGS

Embodiments of the present invention will be described in detail based on the following figures, wherein:

FIG. 1 is a diagram illustrating an example of a sensor network to which the present invention can be applied;

FIG. 2 is a block diagram illustrating a hardware configuration of a sensor node 10 according to an embodiment of the present invention;

FIG. 3 is a temporal diagram illustrating relationship among periods of congestion control, wireless (radio) communication, and infrared communication performed by each sensor node 10 during the active mode;

FIG. 4 shows a communication sequence between the sensor node 10 and a base station 30A according to the first embodiment of the present invention;

FIG. 5 illustrates an example of infrared communication frame and transmission signal waves;

FIG. 6A illustrates an example of front surface appearance of the sensor node 10;

FIG. 6B illustrates an example of rear surface appearance of the sensor node 10;

FIG. 7 illustrates an example of a radio communication frame format;

FIG. 8 illustrates another example of the radio communication frame format;

FIG. 9 shows a communication sequence between the sensor node 10 and a base station 30A according to the second embodiment of the present invention

FIG. 10 is a temporal diagram illustrating relationship among the congestion control period, the radio communication period, and the infrared communication period in the second embodiment of the present invention;

FIG. 11 is a diagram illustrating another embodiment of the sensor network to which the present invention can be applied; and

FIG. 12 is a block diagram illustrating an embodiment of the sensor node 10 applicable to the sensor network illustrated in FIG. 11.

### DETAILED DESCRIPTION OF PREFERRED EMBODIMENTS

Hereinafter, embodiments of the present invention will be described in detail with reference to the accompanying drawings.

In the present description, the term “wireless” is used in describing general media-less communication employing an electromagnetic wave including a radio wave, a light (infrared, visible, ultraviolet light), etc. The term “radio” is used in describing media-less communication employing a radio wave. Therefore, for example, “wireless communication” means either of or both “radio communication” and “infrared communication”. “Radio communication” and “infrared communication” mean respectively different kinds of communication.

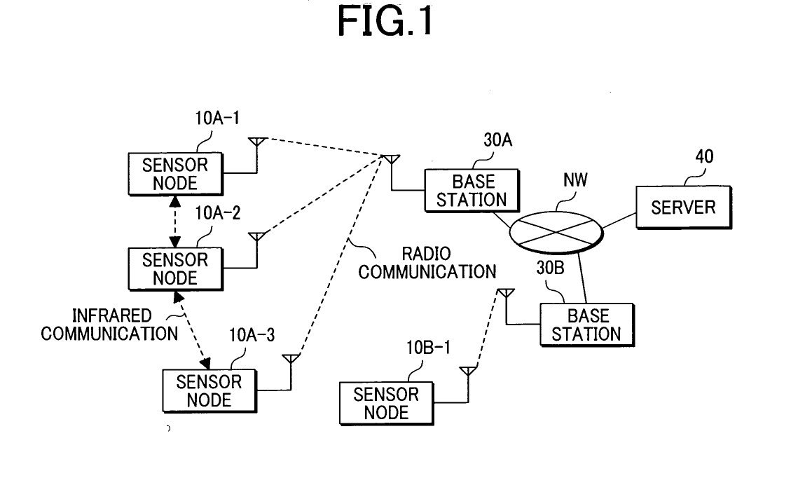

FIG. 1 is a diagram illustrating an example of a sensor network to which the present invention can be applied.

The sensor network comprises a plurality of sensor nodes 10 (10A-1, 10A-2, 10A-3, . . . , 10B-1, . . . ), a plurality of base stations 30 (30A, 30B, . . . ) coupled to a relay network (intranet/Internet) NW, and a server 40 connected to the relay network NW. The server 40 functions as a management apparatus or a monitoring center in the sensor network.

Each sensor node 10 notifies sensing information to the server 40 via any one of the base stations 30. In the illustrated sensor network, the sensor nodes 10A-1 to 10A-3 are located within a communication area of the base station 30A and, and the sensor node 10B-1 is located within a communication area of the base station 10B.

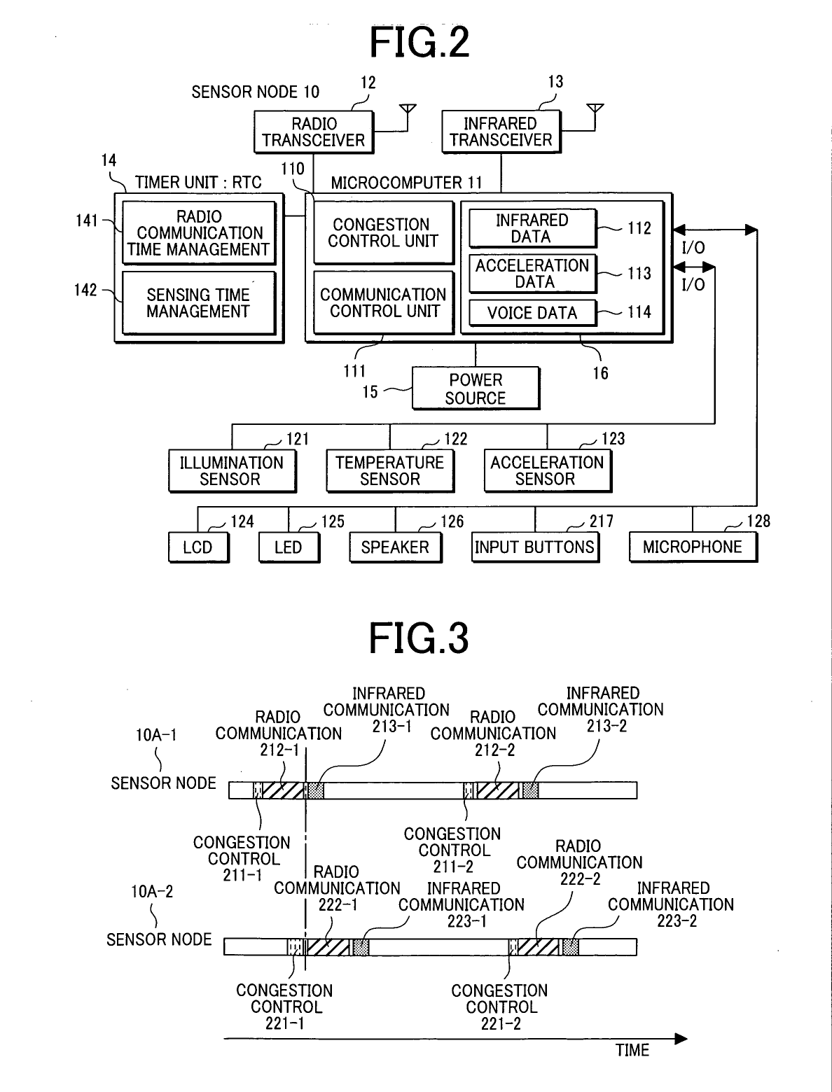

FIG. 2 is a block diagram illustrating a hardware configuration of the sensor node 10 according to an embodiment of the present invention.

The sensor node 10 comprises a microcomputer (a processor unit and a memory) 11, a radio transceiver (a first wireless transceiver) 12, an infrared transceiver (a second wireless transceiver) 13, a timer unit RTC (Real Time Clock) 14, and a power source (battery) 15. The microcomputer 11 is connected to a plurality of sensor units and input/output units via an internal bus.

The sensor node 10 illustrated in FIG. 2 is a wearable sensor node which people can put on, and provided with, as the sensor units, an illumination sensor 121, a temperature sensor 122, and an acceleration sensor 123, and as the input/output units, an LCD (Liquid Crystal Display) 124, an LED (Light Emitting Diode) 125, a speaker (or buzzer) 126, input buttons 127, and a microphone 128.

On the LCD 124, such information as various kinds of sensing data detected by the sensor units, a radio state, a message received from the base station 30, etc. is displayed in a dot format. The LED 125 is used to visualize the operating state of the node, and it is turned on at the time of occurrence of a specific event, for example, at the time of reception of a message. The speaker 126 is used, for example, for reproduction of voice data received from the server 40, and the notice of the specific event by sounding. The input buttons 127 are used for operation of user interfaces, such as scroll operation of the LCD screen and selection of the alternative displayed on the LCD screen. The microphone 128 is one sort of sensors, and gathers the environmental sound and voice information of peoples in the circumference of the sensor node 10. Acquired voice information is processed to voice data and transmitted to the server 40 as a radio packet.

In the present example, the microcomputer 11 is provided with a congestion control unit 110 and a communication control unit 111. The microcomputer 11 is also provided with an infrared data area 112, an acceleration data area 113, and a voice data area 114, as memory areas for storing the sensing data. The timer unit RTC 14 is always operating and manages, for example, a radio communication time by a first timer 141, and a sensing time by a second timer 142. By interruption signals outputted from these timers, the operation mode of the sensor node 10 is switched from the standby mode to the active mode and conversely from the active mode to the standby mode. The operation mode of the sensor node 10 is controlled by the communication control unit 111.

The microcomputer 11 controls whole operations of the sensor node 10 during the active mode, such as control of the input/output unit, output of an instruction for executing sensing to the sensor units, transmission and reception of data by the radio transceiver 12 and the infrared transceiver 13, and others. In the present embodiment, the RTC 14 and the infrared transceiver 13 are always in an operating state. When the sensor node 10 in switched to the standby mode, electronic circuitries, including the microcomputer 11 but excluding the RTC 14 and the infrared transceiver 13, are switched to an OFF state, thereby suppressing the power consumption thereof.

During the active mode, the microcomputer 11 takes sensing data into the memory areas 112 to 114 from the various sensors 121 to 123, generates a radio communication frame including the sensing data and the node identifier, and transmits the radio communication frame to the base station 30 via the radio transceiver 12. During the active mode, the microcomputer 11 also takes in the control data received from the base station 30 by the radio transceiver 12, performs necessary control operations according to the control data, and transmits pulse signals including its sensor node ID information via the infrared transceiver 13, as will be explained in detail later.

The sensor node 10 illustrated here is equipped, for example, in the front part of a person so that it can move around the circumference of the base station depending on the movement of the person. In this case, the sensor node 10 is applicable also to the person-to-person facing detection.

Upon receiving normally a radio frame transmitted from the sensor node 10, the base station 30 returns an ACK signal to the source sensor node 10. By receiving the ACK signal, the sensor node 10 judges that the sensing data which the sensor node 10 has transmitted is received correctly by the base station.

After returning the ACK signal to the source sensor node 10, the base station 30 forwards the received data to the server 40 via the relay network NW. Alternatively, if the sensor node 10, which has received the ACK signal from the base station 30 in the present example, transmits another ACK signal indicating the end of transmission of radio frames, the base station 30 may forward the received data to the server 40 in response to the reception of the ACK signal.

When a plurality of sensor nodes 10 start transmission of radio frames almost simultaneously to the base station 30, there is no return of the ACK signal from the base station 30, because the radio frames can not be normally received due to the collision of the transmission signals of the radio frames. If the ACK signal is not received within a fixed time, each sensor node, which is the source of one of the radio frames, judges that the radio frame has not been received correctly by the base station, and tries to retransmit the same sensing data at the time after a random waiting time passes.

In the present embodiment, in order to avoid retransmission of the same sensing data mentioned above, each sensor node 10 performs a congestion control individually in advance of radio communications with the base station 30. More specifically, in advance of transmission of the radio frame to the base station 30, the congestion control unit 110 of the sensor node 10 judges, by carrier sensing, whether the radio channel of the base station is occupied or not. In other words, the congestion control unit 110 judges whether another sensor node is in the status of radio communication with the base station 30.

If another sensor node is in the status of radio communication with the base station 30, the congestion control unit 110 of the sensor node 10 repeats carrier sensing and waits until the radio communication becomes in a collision-free state. Alternatively, however, the congestion control unit 110 may stop the carrier sensing once and resume it after a random time passes. As a result of the carrier sensing, if it is judged that no sensor node is in communication with the base station 30, the sensor node 10 enters a radio communication state immediately, and transmits a radio communication frame to the base station 30.

As the communication frame between the sensor node 10 and the base station 30, there are an upstream communication frame which is transmitted from the sensor node 10 to the base station 30, and a downstream communication frame which is transmitted from the base station 30 to the sensor node 10. The upstream communication frame is for transmitting to the server 40 sensing data such as temperature, luminance, and acceleration detected by the sensor nodes, and identifiers of other sensor nodes detected by the infrared transceiver. The downstream communication frame is used for providing control commands to the sensor node 10 from the server 40, in order to change the setting value of control parameters, such as time to be set to the clock timer, a sensing interval, a transmission period of the radio frame, a sampling rate, etc. The downstream communication frame also includes the ACK signal frame from the base station 30 to the sensor node 10.

FIG. 3 illustrates the relationship of periods of congestion control, radio communication, and infrared communication performed by each sensor node 10 during the active mode. Here, operations of two sensor nodes 10A-1 and 10A-2, which communicate with the server 40 via the same base station 30A, are illustrated. Each sensor node 10 is switched from the standby mode to the active mode at a predetermined communication period T0 specified by the base station 30, and transmits radio communication frames to the base station 30.

The sensor node 10A-1 having been switched to the active mode performs congestion control 211-1 by carrier sensing in advance of the transmission of a communication frame, and starts radio communication 212-1 with the base station 30 after confirming that the radio communication is in a collision-free state. In the radio communication 212-1, a radio communication frame is transmitted from the sensor node 10A-1 to the base station 30A. When the radio communication frame is received normally, an ACK signal is replied from the base station to the sensor node 10A-1. The present embodiment is characterized by that the sensor node 10A-1 having received the ACK signal from the base station enters an infrared communication state 213-1 immediately, and transmits a communication frame which includes its own node identifier, to other sensor nodes by the infrared transceiver 13.

Even when it has been judged by carrier sensing that the radio communication is in the collision-free state, for example, if the sensor node 10A-2 resides in such a place where the sensor node 10A-2 is undetectable by the carrier sensing from the sensor node 10A-1, the sensor nodes 10A-1 and 10A-2 might start radio communications simultaneously. In this case, a collision might occur in the radio communications. This phenomenon is known as the hidden node problem. Therefore, in the present embodiment, the sensor node 10A-1 starts the infrared communication 213-1 after receiving the ACK signal from the base station 30A. If the ACK signal is unreceivable within a predetermined time duration after transmitting the radio communication frame to the base station 30A, the sensor node 10A-1 retransmits to the base station 30A a radio communication frame which has the same content of the last transmitted radio communication frame, at the time when the waiting time determined at random elapses.

After the infrared communication 213-1 is completed, the sensor node 10A-1 transits to the standby mode, and repeats the next communication sequence including congestion control 211-2, radio communication 212-2, and infrared communication 213-2 in the predetermined period T0 which is designated by the timer 141.

In analogy with the sensor node 10A-1, the sensor node 10A-2, performs the congestion control (221-1) by carrier sensing before transmitting a radio frame to the base station 30 to confirm that none of the other sensor nodes is in radio communication with the base station 30, and starts radio communication (222-1) with the base station 30. Immediately after the communication of the radio frame is terminated normally, the sensor node 10A-2 starts infrared communication with other sensor nodes (223-1).

As mentioned above, in the present embodiment, each sensor node 10 performs the infrared communication immediately after the radio communication with the base station 30 is completed. The start time of the radio communication with the base station varies for each sensor node according to the congestion control performed in advance. The completion of the radio communication and the start timing of the infrared communication are also always different for each sensor node. When the time duration necessary for the congestion control by carrier sensing is included, the radio communication period between the sensor node 10 and the base station 30 is longer than the infrared communication period. For this reason, if each sensor node starts the infrared communication immediately after the radio communication period, the infrared communication period of one sensor node will not overlap with the infrared communication period of another sensor node.

Accordingly, if each sensor node 10 is designed such that the infrared transceiver 13 is ready to receive at any time the infrared signal transmitted from another sensor node, and such that the microcomputer 11 (communication control unit 111) is activated with an interrupt signal issued when the infrared signal was detected, it becomes possible to receive and process the infrared signal including another node identifier.

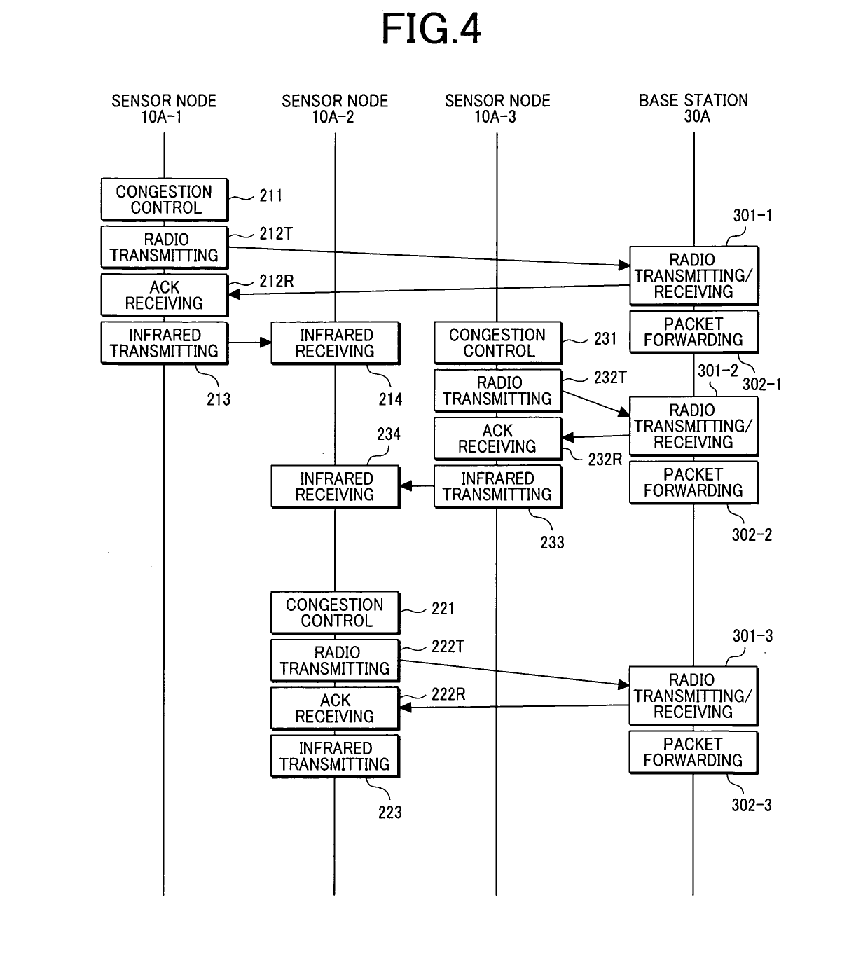

FIG. 4 shows a communication sequence between the sensor node 10 (10A-1 to 10A-3) and the base station 30A according to the first embodiment of the present invention. It is assumed here that the sensor nodes 10A-1 and 10A-2 and the sensor nodes 10A-2 and 10A-3 are in the spatial relationship (in terms of distance and angle) in which an infrared communication is possible mutually, and that the sensor nodes 10A-1 and 10A-3 are in the spatial relationship in which an infrared communication is impossible.

The sensor node 10A-1 performs the congestion control (Step 211) by carrier sensing to confirm that the radio communication is in a collision-free state, and transmits a radio communication frame to the base station 30A (Step 212T). Upon succeeding in receiving the radio communication frame, the base station 30A returns an ACK frame to the sensor node 10A-1 (Step 301-1), and forwards to the server 40 the content of the received frame as a data packet (Step 302-1). Upon receiving the ACK signal from the base station 30A (Step 212R), the sensor node 10A-1 transmits its own node identifier in the predetermined direction by infrared transmitting (Step 213). The node identifier transmitted from the sensor node 10A-1 is received by the sensor node 10A-2 (Step 214).

In analogy with the sensor node 10A-1, the sensor node 10A-3 also performs the congestion control (Step 231) by carrier sensing to confirm that the radio channel is unoccupied, and transmits a radio communication frame to the base station 30A (Step 232T). Upon succeeding in receiving the radio communication frame, the base station 30A returns an ACK frame to the sensor node 10A-3 (Step 301-2), and forwards to the server 40 the content of the received frame as a data packet (Step 302-2). Upon receiving the ACK signal from the base station 30A (Step 232R), the sensor node 10A-3 transmits its own node identifier in the predetermined direction by infrared transmitting (Step 233). The node identifier transmitted from the sensor node 10A-3 is received by the sensor node 10A-2 (Step 234).

The sensor node 10A-2 stores the node identifiers of other sensor nodes (in the present case, the node identifiers of sensor nodes 10A-1 and 10A-3) detected by the infrared communication, and at the time of the next radio communication, the sensor node 10A-2 transmits the stored node identifier as a part of sensing data, in the form of radio communication frame to the base station 30A (Step 222T). Similarly as in the sensor node 10A-2, when the sensor nodes 10A-1 and 10A-3 have received the node identifier of other sensor nodes by the infrared communication, the sensor nodes 10A-1 and 10A-3 transmit the received node identifier of other sensor nodes to the base station 30A in the form of a radio communication frame.

In the infrared transmitting (Steps 213, 223, 233) performed following the radio communication, it is sufficient to transmit only the node identifier proper to each sensor node. Therefore, the infrared communication can complete in a time shorter than the time required for the radio communication (212T-212R, 222T-222R, and 232T-232R).

As in the present embodiment, in the case where each sensor node starts the radio communication with the base station after confirming by the individual congestion control that the radio communication is in a collision-free state, and starts the infrared communication immediately after the end of the radio communication, there is no possibility that conflict occurs in the infrared communications performed by the plurality of sensor nodes. For example, when the sensor node 10A-1 performs infrared transmitting 213, the sensor node 10A-3 is in the course of executing the congestion control (231) or immediately after starting the radio communication (232T-232R). Accordingly, the infrared transmitting 233 that the sensor node 10A-3 starts after the radio communication and the infrared transmitting 213 by the sensor node 10A-1 do not overlap in time.

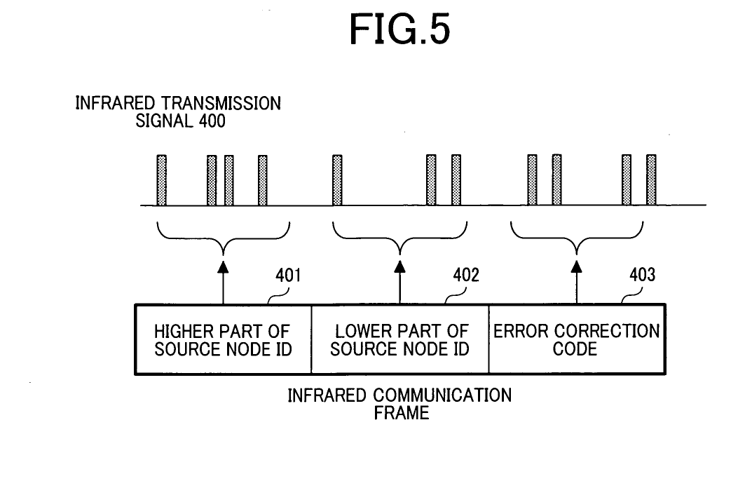

FIG. 5 illustrates an example of an infrared communication frame and transmission signal waves.

The communication frame to be transmitted by an infrared ray comprises a field 401 indicative of the higher part of the source sensor node ID, a field 402 indicative of the lower part of the source sensor node ID, and a field 403 indicative of the error correction code. The infrared transceiver 13 of each sensor node encodes the communication frame and transmits it as an infrared pulse signal 400.

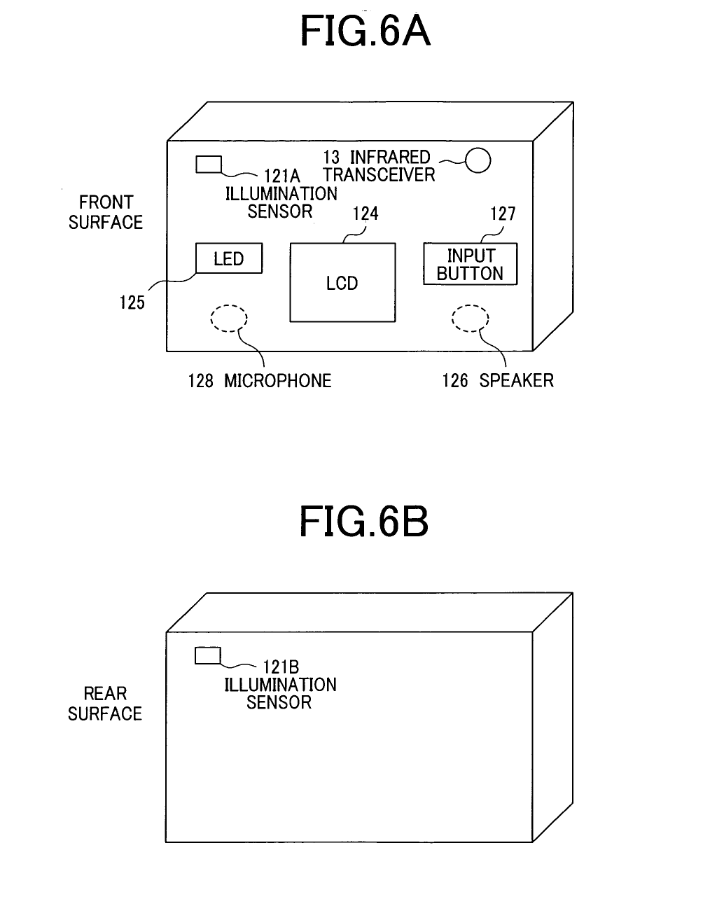

FIG. 6A illustrates an example of front surface appearance of the sensor node 10, and FIG. 6B illustrates an example of rear surface appearance of the sensor node 10.

On the front surface of the sensor node 10, the LCD 124, LED 125, input buttons 127, speaker 126, and microphone 128 are mounted. The microcomputer 11, RTC 14, battery 14, and acceleration sensor 123 are built in the node case. The infrared transceiver 13 is mounted on the front surface of the sensor node 10.

The illumination sensors 121 (121A, 121B) are mounted on both the front surface and the rear surface, so that the direction of the node can be judged. The microcomputer 11 compares the output of the illumination sensor 121A with the output of the illumination sensor 121B. When the output of illumination sensor 121A is found to be clearly lower, for example, the microcomputer 11 judges that the infrared transceiver 13 is in a state of being covered by the object or the human body, and halts the infrared communication. When it is judged, from the output signal of the acceleration sensor 123, that the motion of sensor node is very intense, the microcomputer 11 also halts the infrared communication because the possibility of correctly receiving the infrared transmission signal by a partner node is vary small.

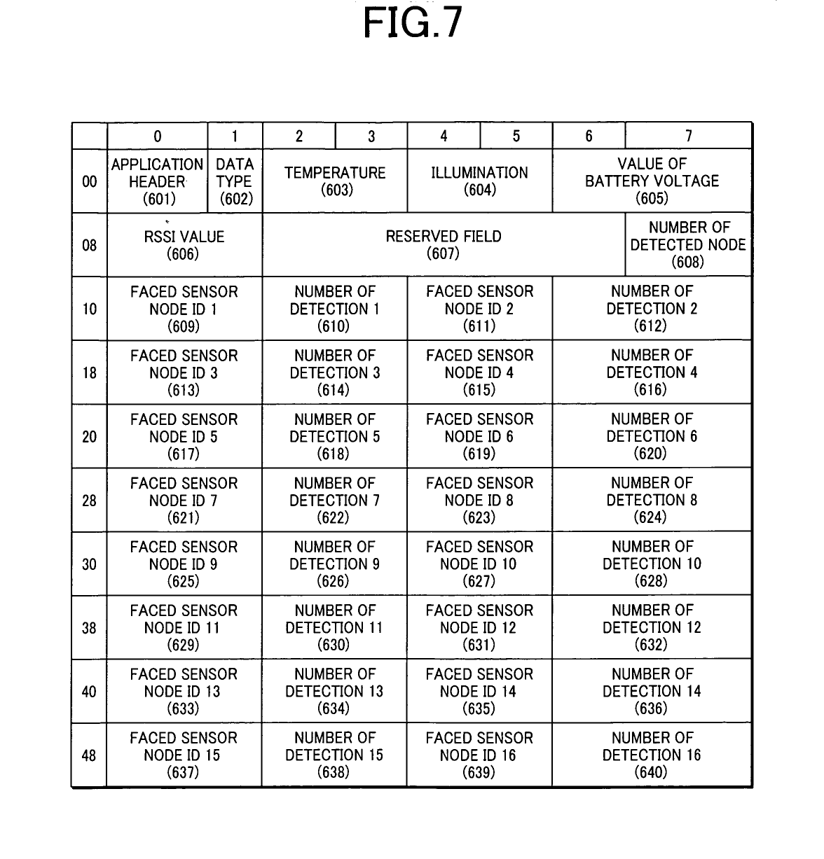

FIG. 7 illustrates an example of the radio communication frame for transmitting the detection result by various sensors and the detection result by the infrared transceiver 13.

An application header field 601 indicates the kind of application applied to the sensor network. A data type field 602 indicates the format identification information of the radio communication frame. A temperature field 603 indicates the sensing data detected by the temperature sensor 122 and a luminance field 604 indicates the sensing data detected by the illumination sensor 121. When multiple times of sensing are performed in the transmission period of the radio communication frame, the latest sensing data is adopted. A battery voltage value field 605 indicates the value of output voltage of power source 15.

An RSSI (Received Signal Strength Indicator) value field 606 indicates the measured value of wave strength of radio signals, such as an ACK signal received from the base station. A reserved field 607 is an unused field and filled with zeros. A detected-node number field 608 indicates the number N of other sensor nodes detected in the radio communication period T0 by the infrared communication, i.e., the number of the sensor node identifiers with different values received within the period T0.

A field of faced sensor node ID k (k=1-16) (609, 611, 613, . . . , 639) indicates the identifier of the k-th sensor node within the N-piece of sensor nodes which are detected. A field of number of detection k (610, 612, . . . , 640) indicates the number of detection (the number of times of reception) of the k-th sensor node identifier in the period T0. The number of the field of faced sensor node ID and the field of number of detection is determined depending on the maximum number of sensor nodes that each base station can accommodate.

In the present embodiment, each sensor node stores, in a table format, the sensor node identifier having been received from other sensor nodes and the number of detection for each identifier in each period T0, and transmits them to the base station 30, together with the sensing data 603 and 604 detected by the sensor units and battery voltage value 605, in the format of radio communication frame shown in FIG. 7

Since retransmission of the same data is necessary when the base station 30 fails in receiving the radio frame, it is preferable for the sensor node to prepare two tables, an odd-period table and an even-period table, so as to store the detected information in either one of the tables which are alternately switched for every period, and to clear the content of the table used in the preceding period at the time when the data transmission ends successfully.

In the present embodiment, since the reception time for each node identifier is counted, even if the number of infrared communication in the period T0 increases, memory space required for the data accumulation can be fixed. Therefore, the format of radio communication frame mentioned above is suitable for transmitting multi-times of infrared communication records. Even when the transmission period T0 of sensing data is changed, the data transmission from each sensor node to the base station can be advantageously performed in the fixed format. The sensor node adopting this format of radio communication frame is hereinafter called as the first type system.

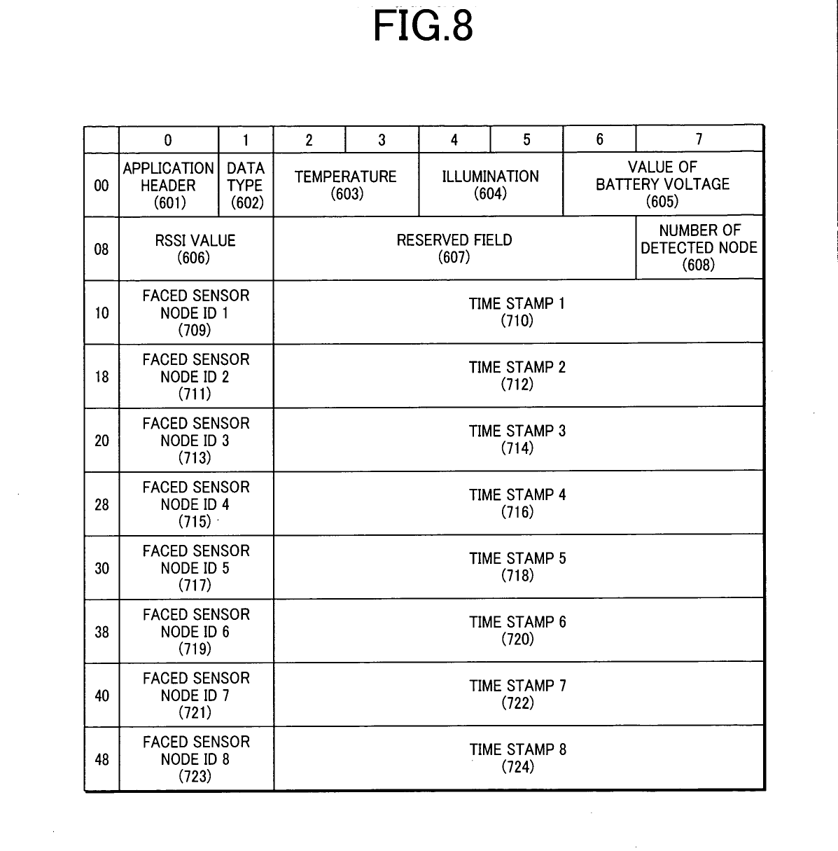

FIG. 8 indicates another embodiment of the radio communication frame.

Fields 601 and 608 are the same as those of FIG. 7. A field of faced sensor node ID k (k=1-8) (709, 711, 713, . . . , 723) indicates the identifier of the k-th sensor node within the detected N-piece of sensor nodes. A time stamp field (710, 712, . . . , 724) indicates the receipt time of the k-th sensor node identifier.

In the present embodiment, the receipt time (time stamp) for each sensor node identifier received in the period T0 is notified to the base station 30. For this reason, an increase of the number of infrared communication in the period T0 will also result in an increase of the memory space required for the data storage. Therefore, this radio communication frame is suitable when each sensor node has a sufficiently large memory space for the data storage. The sensor node adopting this format of radio communication frame is hereinafter called as the second type system.

Although the radio communication frames of FIG. 7 and FIG. 8 include both the sensing information and the node identifier information, it may be preferable to transmit either of the information to the base station depending on the application. An alternative system is conceivable, in which the infrared detection time is obtained in units of sensing period, without enlarging the radio communication frame size as in the system of FIG. 8, by separating the wireless transmission period and the sensing period. The sensor node adopting this format of radio communication frame is hereinafter called as the third type system.

In the third type system, the time stamp is given for each sensing period. In the second type system using the frame format shown in FIG. 8, whenever an infrared frame is detected, the detection time thereof is recorded. On the other hand, according to the third type system, since the time stamp is given for each sensing period, data size can be advantageously made smaller compared with the counterpart in the second type system. Furthermore, it is possible to acquire the infrared detection time more finely compared with the first type system.

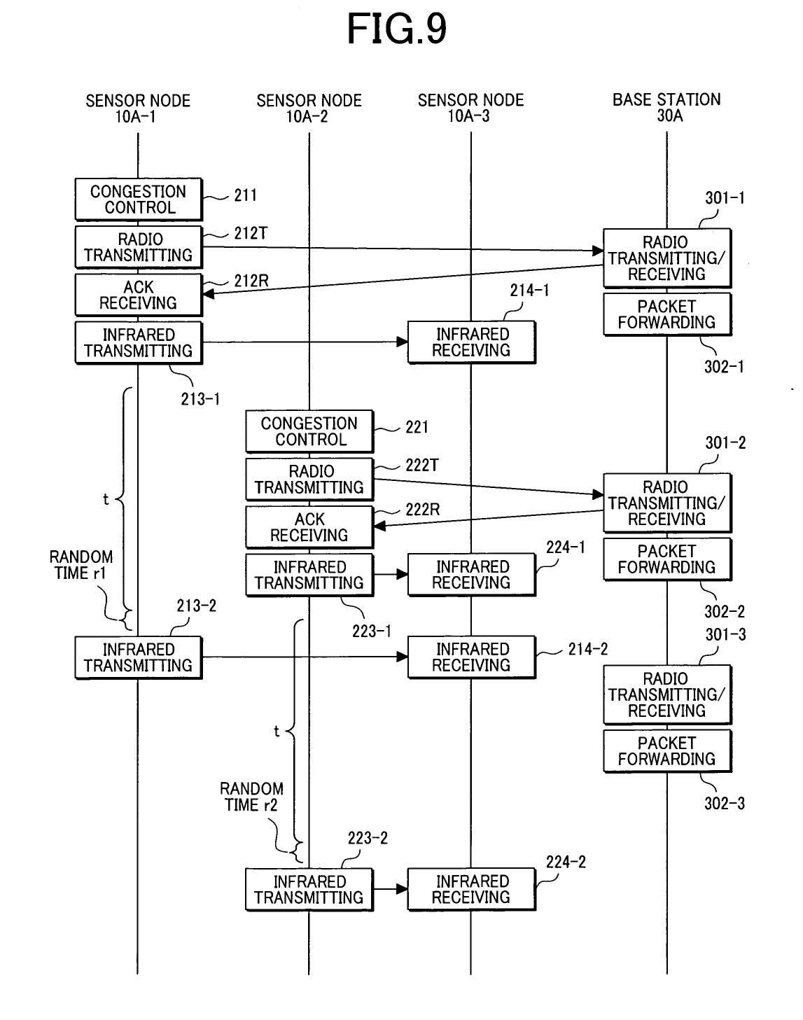

FIG. 9 shows a communication sequence between the sensor node 10 (10A-1 to 10A-3) and the base station 30A according to the second embodiment of the invention.

This embodiment is characterized by that each sensor node having completed the radio communication with the base station repeats transmission of the sensor node identifier by the infrared communication two or more times in the radio communication period T0.

As described before, each sensor node 10 performs the congestion control individually to start the radio communication (212, 222, 232 . . . ). For this reason, in the infrared communication performed immediately after the radio communication, each sensor node can transmit the node identifier without conflicting with other sensor nodes. However, in the second or later infrared communication performed in the same period T0, there is no guarantee that conflict with other sensor nodes can be avoided.

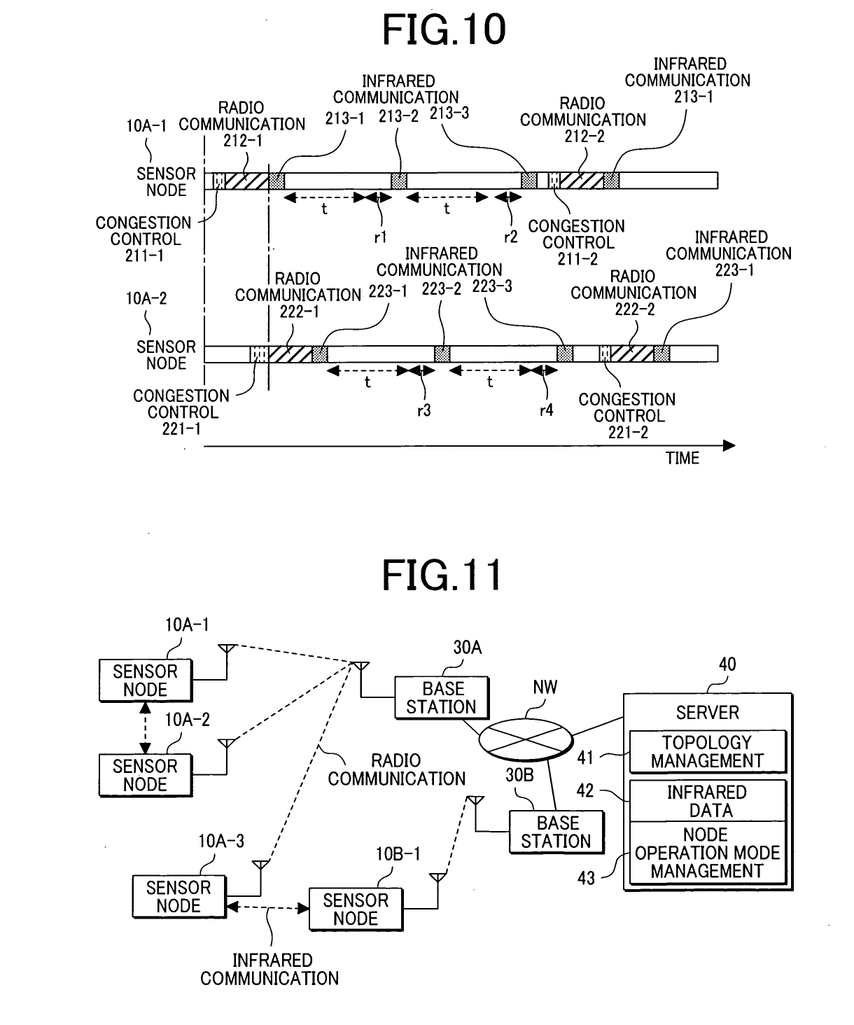

According to the present embodiment, as illustrated in FIG. 10, each sensor node performs the second or later infrared communication at the time when t±r (“t” is fixed time and “r” (=r1, r2, r3, r4 . . . ) is random time) has passed since the last transmission time, so that the infrared communication may not overlap with the first infrared communication of other sensor nodes. The random time “r” is set longer than the time required of the infrared communication, and shorter than the fixed time “t,”. According to the present example, since the node identifier detection by the infrared communication can be performed more frequently than the first embodiment shown in FIG. 4, the change in a positional relation between the sensor nodes is precisely detectable.

FIG. 11 is a diagram illustrates another embodiment of the sensor network to which the present invention can be applied.

The present embodiment assumes a case where an infrared communication is performed between the sensor nodes 10A-3 and 10B-1 belonging to mutually different base stations, as illustrated in FIG. 11. The server 40 includes a topology management unit 41, an infrared data management unit 42, and a node operation mode management unit 43.

Since base stations 30A, 30B, . . . , of the sensor network use different radio channels to each other, even while the sensor node 10A-3 is performing a radio communication with the base station 30A, for example, the sensor node 10B-1 belonging to another base station 30B can start and terminate a radio communication normally. Therefore, if each sensor node is let to start an infrared communication immediately after the end of the radio communication, the infrared communications of the sensor nodes 10A-3 and 10B-1 are performed simultaneously. Hence, there is probability of resulting in failure of infrared communication depending on conditions.

In the present embodiment, the server 40 supervises to which base station each sensor node belongs currently by a topology management unit 41. The infrared data management unit 42 supervises the infrared communication between the sensor nodes which belong to different base stations, for example, like the sensor nodes 10A-3 and 10B-1. The node operation mode management unit 43 manages the mode of operation of each sensor node. Upon detecting the start of the infrared communication between sensor nodes which belong to different base stations, the server 40 transmits to the sensor nodes concerned (10A-3 and 10B-1 in FIG. 11), a transit instruction which instructs transition to an infrared ACK issue mode.

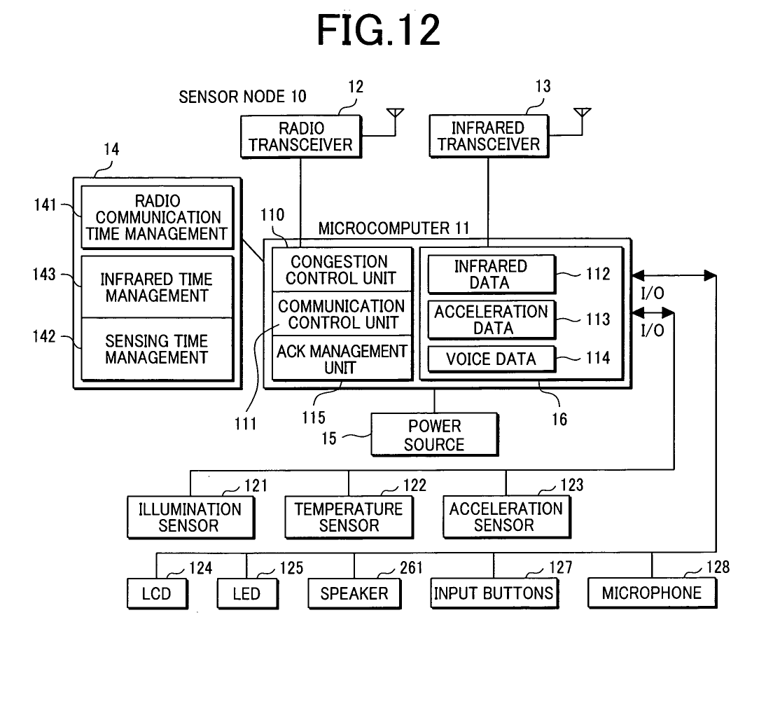

FIG. 12 illustrates an embodiment of the sensor node which can cope with the conflict of the infrared communication mentioned above.

The sensor node 10 of the present embodiment is characterized by that the microcomputer 11 includes an ACK management unit 115 and the RTC 14 includes a third timer 143 for infrared communication time management.

The sensor node having received the transit instruction for transition to the infrared ACK issue mode changes its operation mode to the infrared ACK mode by the ACK management unit 115. The sensor node in the infrared ACK mode returns an ACK signal when a node identifier is received normally from one of the other sensor nodes by infrared communication. On the other hand, when the sensor node transmits its node identifier by infrared transmitting, the sensor node waits for receiving an ACK signal. If no ACK signal is received within a predetermined time period after the transmission of node identifier, the sensor node retransmits the node identifier. The retransmission of the node identifier is performed at the time when a random time (t±r) explained with reference to FIGS. 9 and 10 has passed, in response to an interrupt signal from the third timer 143 used for infrared communication time management.

The server 40 supervises the state of a sensor node operating in the infrared ACK mode, and issues an infrared ACK mode release instruction at the time when it is detected that the sensor nodes 10A-3 and 10B-1 belong to the same base station. The sensor node having received the infrared ACK mode release instruction returns its operation mode to the normal mode by the ACK management unit 115. The sensor node having returned to the normal mode operates in the infrared communication mode explained with reference to FIG. 4 or FIG. 9.

As apparent from the above explanation, according to the present invention, each sensor node can perform radio communication with a base station and infrared communication between sensor nodes, without conflicting with other sensor nodes.

When the present invention is applied to a wearable name-badge-type sensor node, people's facing situation can be detected, so that various application, for example, such as monitoring and analyzing of a person-to-person facing situation, and selection of a person who is acting as a hub of the organization based on the active degree of communication become possible. Furthermore, application to organization management becomes possible, by analyzing the change in the people's facing situation and the active degree of communication before and after the introduction of a new system or the reassignment.

When the present invention is applied to a stationary sensor node, for example, the presence information of a member is acquirable with a sensor node installed on a desk, by detecting automatically whether the person wearing the name-badge-type sensor node is present at the desk.

What is claimed is:

1. A wireless terminal apparatus comprising:
a first wireless transceiver for communicating with a base station;
a second wireless transceiver for communicating with the other wireless terminals;
a congestion control unit for detecting whether the base station is in the state of wireless communication with one of the other wireless terminals; and
a communication control unit for performing wireless communication with said base station by said first wireless transceiver after confirming by said congestion control unit that the wireless communication is in a collision-free state, and for transmitting information to at least one of the other wireless terminals by said second wireless transceiver when the wireless communication with said base station was completed.

2. The wireless terminal apparatus according to claim 1,
wherein a time required for transmitting information by said second wireless transceiver is shorter than a time required for performing wireless communication by said first wireless transceiver.

3. The wireless terminal apparatus according to claim 1,
wherein said communication control unit enters an active mode in a predetermined cycle and performs detection of the wireless communication state by said congestion control unit and wireless communications by said first wireless transceiver and said second wireless transceiver, and transits to a standby mode after completing information transmission to one of said the other wireless terminals.

4. The wireless terminal apparatus according to claim 3, further comprising:
at least one sensor,
wherein said communication control unit transmits sensing data detected by the sensor to said base station.

5. The wireless terminal apparatus according to claim 1, further comprising:
a memory for storing information received from the other wireless terminals by said second wireless transceiver,
wherein said communication control unit transmits to said base station a communication frame including the information received from said the other wireless terminals and stored in the memory.

6. The wireless terminal apparatus according to claim 5,
wherein said communication control unit transmits identification information of the wireless terminal apparatus to one of said the other wireless terminals by said second wireless transceiver, and transmits to said base station a communication frame including identification information of said the other wireless terminals received within a prescribed period.

7. The wireless terminal apparatus according to claim 6,
wherein said communication control unit repeats information transmission by said second wireless transceiver a plurality of times at a random interval within a predetermined period after communication with said base station by said first wireless transceiver was completed.

8. The wireless terminal apparatus according to claim 7, further comprising:
a state sensor for detecting direction of said second wireless transceiver,
wherein said communication control unit judges, according to an output of the state sensor, whether the information transmission by said second wireless transceiver should be performed.

9. A wireless communication system comprising:
a plurality of wireless terminals; and
a plurality of base stations connected to a management apparatus via a network,
wherein each of said wireless terminals includes:
a first wireless transceiver for communicating with one of said base stations;
a second wireless transceiver for communicating with the other wireless terminals;
a congestion control unit for detecting whether wireless communication with said wireless base station is in a collision-free state; and
a communication control unit for performing wireless communication with said base station by said first wireless transceiver after confirming by said congestion control unit that the wireless communication is in a collision-free state, and transmitting information to at least one of said the other wireless terminals by said second wireless transceiver when the wireless communication with said base station by said first wireless transceiver was completed, and
wherein each of said base stations forwards content of a communication frame received from each of said wireless terminals to said management apparatus.

10. The wireless communication system according to claim 9,
wherein each of said wireless terminals includes at least one sensor, and said communication control unit transmits sensing data detected by the sensor to said wireless base station.

11. The wireless communication system according to claim 10,
wherein each of said wireless terminals includes a memory for storing information received from said the other wireless terminals by said second wireless transceiver, and said communication control unit transmits to said base station, a communication frame including information received from said the other wireless terminals and stored in said memory.

12. The wireless communication system according to claim 11,
wherein each of said wireless terminals transmits its own identification information to said the other wireless terminal apparatus by said second wireless transceiver, and transmits to said base station, a communication frame including identification information of said the other wireless terminals received within a predetermined period.

13. The wireless communication system according to claim 12,
wherein each of said wireless terminals transmits to said base station, a communication frame including identification information received from said the other wireless terminals within a predetermined period and number of times of receiving the identification information.

14. The wireless communication system according to claim 11,
wherein each of said wireless terminals transmits to said base station, a communication frame including identification information received from the other wireless terminals within a predetermined period and reception time of the identification information.

15. The wireless communication system according to claim 14,
wherein each of said wireless terminals includes at least one sensor and transmits to said base station, the communication frame further including sensing data detected by the sensor.
